(19) United States
(12) Patent Application Publication
(10) Pub. No.: US 2011/0219308 A1
(43) Pub. Date: Sep. 8, 2011

(54) PRE-PROCESSING AND ENCODING MEDIA CONTENT

(75) Inventors: Arjun Ramamurthy, Glendale, CA (US); Geoffrey Anton Bloder, Los Angeles, CA (US); James Frank Heliker, San Bernardino, CA (US)

(73) Assignee: TWENTIETH CENTURY FOX FILM CORPORATION, Los Angeles, CA (US)

(21) Appl. No.: 12/715,989

(22) Filed: Mar. 2, 2010

(51) Int. Cl. G06F 3/00; H04N 5/445

(52) U.S. Cl. 715/719; 725/38

(57) ABSTRACT

A method, apparatus, system, article of manufacture, and computer readable storage medium provide the ability to generate a media content deliverable. Media content is defined and template files are established. Each template file contains settings used to generate one or more commands that operate on the media content to output a different deliverable. One or more of the template files are selected and master settings for the media content is specified. Commands are then generated that are based on each of the selected template files and the master settings. Further, the commands are utilized to output one or more of the deliverables.

### CROSS-REFERENCE TO RELATED APPLICATIONS

This application is related to the following co-pending and commonly-assigned patent application, which application is incorporated by reference herein:

U.S. patent application Ser. No. --/xxx,xxx, entitled “DELIVERY OF ENCODED MEDIA CONTENT”, by Arjun Ramamurthy and Kai Tao Huang, Attorney Docket No. 241.8-US-01, filed on the same date herewith

### BACKGROUND OF THE INVENTION

1. Field of the Invention

The present invention relates generally to processing and generating media content, and in particular, to a method, apparatus, system, article of manufacture, and computer readable medium for efficiently producing different media content deliverables.

2. Description of the Related Art

Media content may be provided/delivered to a variety of different entities for viewing or further modifications. Each of the different entities may have different requirements for the media content relating to both the media content itself as well as the specification/format of the media content. For example, a first web based entity that is going to display/stream the media content across the Internet to end-users may require the media content in MPEG2 (motion pictures expert group version 2) while a second web based entity may require the media content in MPEG-4. In another example, a domestic broadcasting entity may require the media content in NTSC (national television system committee) 4×3 aspect ratio, 30 fps (frames per second) while a foreign broadcasting entity may require PAL (phase alternating line) 16×9 aspect ratio at 25 fps. Further, the content itself may be modified or edited per the requirements of the receiving entity (e.g., shorter/no commercials, or no black bars on a 4×3 formatted program, etc.). The different versions of the media content is referred to herein as a deliverable. Prior art mechanisms fail to provide the capability to easily, efficiently, and economically generate a deliverable for a receiving entity. To better understand these problems, a description of prior art media content processing is useful.

Media content is obtained using a variety of mechanisms (e.g., film, video, computer generated, etc.) and stored onto tape. The media content may then be transformed/encoded, transcoded into a deliverable and stored onto a different tape. The various deliverables (each on a different tape) are then manually delivered to the desired recipient(s). About 65,000 tapes per year are delivered throughout the world. Such tape usage is not only expensive, but is time-consuming and consumes resources.

The prior art transformation of the master (i.e., media content on tape) into a deliverable is a time-consuming and inefficient process. FIG. 1 illustrates the prior art process for creating a deliverable. The tape 102 is first processed via a capture tool that transforms the media content into a file 104. A variety of products from different manufacturers (e.g., from Digital Rapids™, AmberFin™, Rhozet™, etc.) may be used to perform the capture. Once in a file 104, the media content can be used to feed multiple different deliverables 110.

To provide a deliverable 110, the source file must be transcoded from the master into the deliverable format. To configure the transcoder, a profile 106 for each deliverable 110 is established. A profile 106 includes configuration parameters and determines what is needed in the file 104 to be used as the deliverable 110. Such configuration parameters may include height and width, bit rate, type of compression, compression ratio, etc. As described above, a television show configured for broadcast viewing may be very different than that for Internet viewing (e.g., media content may be shot with very dark lighting for broadcast that would not be acceptable for Internet viewing). Accordingly, the television show would need one deliverable 110 for the particular broadcast viewing and a second deliverable 110 for the particular Internet viewing.

Each different profile 106 is associated with a single watch folder 108. When a user desires to generate a particular deliverable 110, the user drops the file 104 into the desired watch folder 108. The profile 106 is then automatically applied to the file 104 to generate/encode/transcode the deliverable 110. To activate another profile 106 and produce a different deliverable 110, the user must manually drop the file 104 into a different watch folder 108. For example, a user may drop the file 104 into watch folder 108C. Profile 106C would then be applied to generate/encode/transcode deliverable 110C. To create a different deliverable 110B, the user would drop the file 104 into watch folder 108B. Accordingly, users need to maintain a knowledgebase regarding which watch folder 108 corresponds to which profile 106 and manually move a file 104 into a particular watch folder 108 in order to generate the desired deliverable 110. The process 100 consumes the entire file 104 and produces a deliverable 110 as a single file.

Such a prior art approach has many problems and inefficiencies. For example, the prior art profiles 106 utilized have limited capabilities and do not provide the ability to perform any advanced editing procedures (e.g., compositing, audio/video multiplexing, etc.). In addition, to generate a particular deliverable, the user is required to manually drop the file 104 into the desired watch folder 108. Further, the profile 106 defines the various parameters and configurations for a particular manufacturer that will generate the deliverable 110. Such manufacturers process each file 104 utilizing their own proprietary internal frame servers and processing capabilities. Accordingly, the profiles 106 and the configurations are limited to the capabilities of the particular manufacturer's processing capabilities. In this regard, prior art techniques require a transcoder to interact with the raw code required to use the profile in their workflows. Further, each manufacturer's encoder processes the content in their own sequence/order, regardless of the efficiency/inefficiency and end result of such a sequence. In addition, as the processing to produce the deliverable 110 is provided by a third party encoding tool, there is no capability to dynamically preview and review a deliverable 110.

In view of the above, what is needed is the capability for a content owner (or authorized party) to perform advanced editing operations, control the sequence of processing, and preview a future deliverable result, in an efficient, cost effective, and easy manner.

### SUMMARY OF THE INVENTION

One or more embodiments of the invention provide the capability to create/encode the source file into various deliverable formats by processing via a frame server. Various templates are established that provide the configuration and parameters for processing the source file into a different format. Each template establishes a coded set of instructions (e.g., scripts) that provides an order/sequencing and profile that is used by a frame server to process the source file. The template provides options for modifying and editing material, from retiming material to a new frame rate, switching colorspace (e.g., from standard definition to high definition), or simply trimming the in and out points of a program.

Multiple different templates can be selected for the different deliverables desired and the source files is then processed one frame at a time to produce multiple different media content streams based on the selected templates. Accordingly, embodiments of the invention may operate as a frameserver, providing near-instant processing without the need for temporary video files to be rendered.

### BRIEF DESCRIPTION OF THE DRAWINGS

Referring now to the drawings in which like reference numbers represent corresponding parts throughout:

FIG. 1 illustrates the prior art process for creating a deliverable;

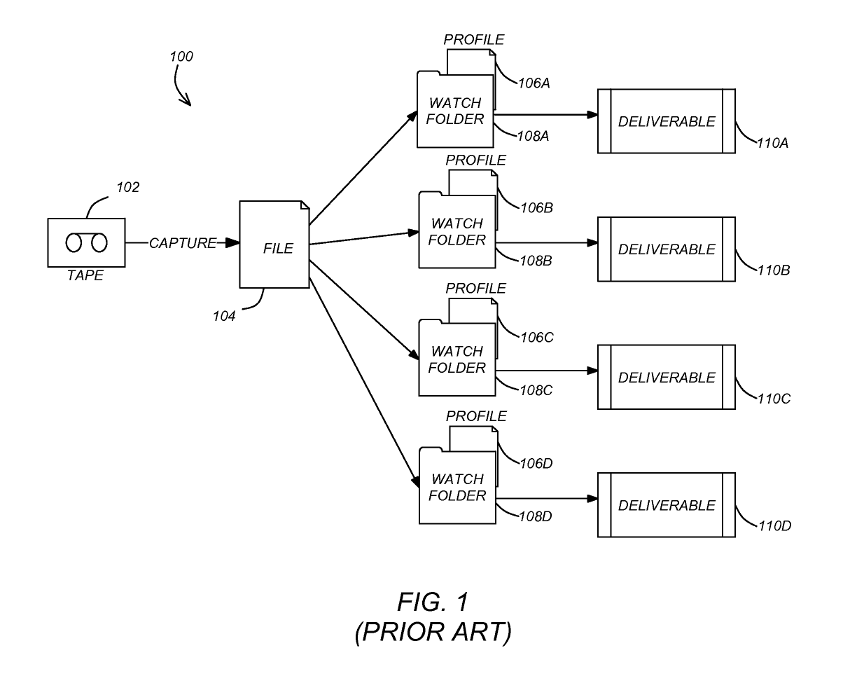

FIG. 2 is an exemplary hardware and software environment used to implement one or more embodiments of the invention;

FIG. 3 illustrates a graphical user interface of an encoding tool in accordance with one or more embodiments of the invention;

FIG. 4 illustrates a source file definition user interface that may be utilized to select and add source files in accordance with one or more embodiments of the invention;

FIG. 5 illustrates a sample slate details user interface that can be used to configure a slate to be utilized as the master slate for all distributables in accordance with one or more embodiments of the invention; and

FIG. 6 illustrates the logical flow for enabling the generation of a broadcast media content deliverable in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Hardware Environment

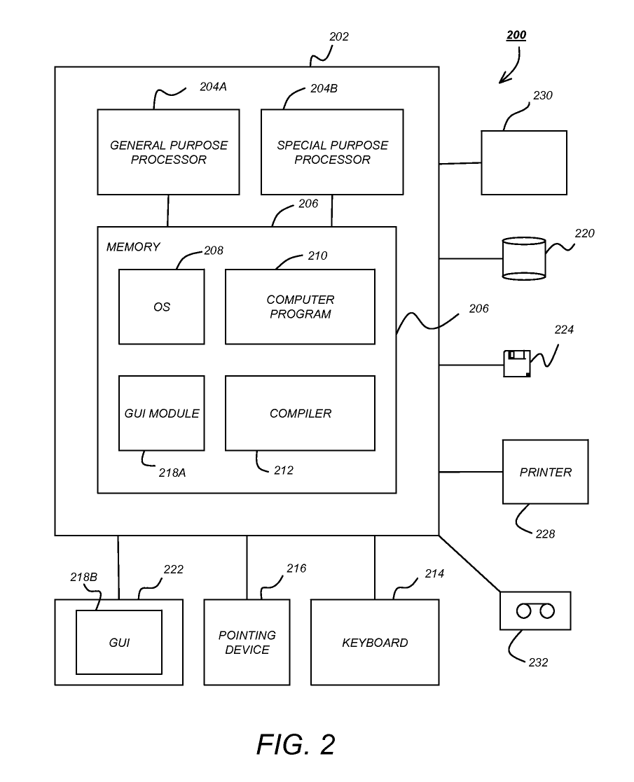

FIG. 2 is an exemplary hardware and software environment 200 used to implement one or more embodiments of the invention. The hardware and software environment includes a computer 202 and may include peripherals. Computer 202 may be a user/client computer, server computer, or may be a database computer. The computer 202 comprises a general purpose hardware processor 204A and/or a special purpose hardware processor 204B (hereinafter alternatively collectively referred to as processor 204) and a memory 206, such as random access memory (RAM). The computer 202 may be coupled to other devices, including input/output (I/O) devices such as a keyboard 214, a cursor control device 216 (e.g., a mouse, a pointing device, pen and tablet, etc.), printer 228, and tape capture device 232.

In one embodiment, the computer 202 operates by the general purpose processor 204A performing instructions defined by the computer program 210 under control of an operating system 208. The computer program 210 and/or the operating system 208 may be stored in the memory 206 and may interface with the user and/or other devices to accept input and commands and, based on such input and commands and the instructions defined by the computer program 210 and operating system 208 to provide output and results.

Output/results may be presented on the display 222 or provided to another device for presentation or further processing or action. In one embodiment, the display 222 comprises a liquid crystal display (LCD) having a plurality of separately addressable liquid crystals. Each liquid crystal of the display 222 changes to an opaque or translucent state to form a part of the image on the display in response to the data or information generated by the processor 204 from the application of the instructions of the computer program 210 and/or operating system 208 to the input and commands. The image may be provided through a graphical user interface (GUI) module 218A. Although the GUI module 218A is depicted as a separate module, the instructions performing the GUI functions can be resident or distributed in the operating system 208, the computer program 210, or implemented with special purpose memory and processors.

Some or all of the operations performed by the computer 202 according to the computer program 210 instructions may be implemented in a special purpose processor 204B. In this embodiment, the some or all of the computer program 210 instructions may be implemented via firmware instructions stored in a read only memory (ROM), a programmable read only memory (PROM) or flash memory within the special purpose processor 204B or in memory 206. The special purpose processor 204B may also be hardwired through circuit design to perform some or all of the operations to implement the present invention. Further, the special purpose processor 204B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 202 may also implement a compiler 212 which allows an application program 210 written in a programming language such as COBOL, Pascal, C++, FORTRAN, or other language to be translated into processor 204 readable code. After completion, the application or computer program 210 accesses and manipulates data accepted from I/O devices and stored in the memory 206 of the computer 202 using the relationships and logic that was generated using the compiler 212.

The computer 202 also optionally comprises an external communication device such as a modem, satellite link, Ethernet card, or other device for accepting input from and providing output to other computers.

In one embodiment, instructions implementing the operating system 208, the computer program 210, and the compiler 212 are tangibly embodied in a computer-readable medium, e.g., data storage device 220, which could include one or more fixed or removable data storage devices, such as a zip drive, floppy disc drive 224, hard drive, CD-ROM drive, tape drive, etc. Further, the operating system 208 and the computer program 210 are comprised of computer program instructions which, when accessed, read and executed by the computer 202, causes the computer 202 to perform the steps necessary to implement and/or use the present invention or to load the program of instructions into a memory, thus creating a special purpose data structure causing the computer to operate as a specially programmed computer executing the method steps described herein. Computer program 210 and/or operating instructions may also be tangibly embodied in memory 206 and/or data communications devices 230, thereby making a computer program product or article of manufacture according to the invention. As such, the terms “article of manufacture,” “program storage device” and “computer program product” as used herein are intended to encompass a computer program accessible from any computer readable device or media.

Of course, those skilled in the art will recognize that any combination of the above components, or any number of different components, peripherals, and other devices, may be used with the computer 202.

Although the term “user computer” or “client computer” is referred to herein, it is understood that a user computer 202 may include portable devices such as cell phones, notebook computers, pocket computers, or any other device with suitable processing, communication, and input/output capability.

### Software Embodiments

Overview

Embodiments of the invention overcome the problems of the prior art performing various actions utilizing one or more computer programs 210 and computer systems 202. Similar to the prior art, media content on tape (e.g., a high resolution master) is first captured using tape capture tool 232 to produce a digital file. Thereafter, embodiments of the present invention diverge from the prior art practices.

An encoding tool is utilized to perform pre-processing on the media content in the digital file. The pre-processing enables the creation of one or more different deliverables from the same digital file without manually dropping a file into a watch folder assigned to a particular profile. Further, the content provider can configure the pre-processing and the sequence of the pre-processing without the limitations/restrictions of a third party encoder. Once the configurations for the various deliverables have been established, the user may select one or more of the desired deliverables and the encoding tool provides pre-processing instructions to process the digital files one frame at a time and outputs it to the encoding device.

Encoding Tool Details

To utilize the encoding tool to perform the pre-processing, various template files are established for each different deliverable. Each template file provides the parameters, sequence, and conditions for performing the pre-processing to output a particular deliverable. In this regard, the template file may provide the ability to perform multiple editing operations (while specifying the sequence for the performance of such operations) such as a compositing operation (e.g., overlaying an image on top of video), a frame rate conversion, a color conversion, a cadence correction, a 4×3 extraction, etc. The template file is created and stored. Users can then merely select one or more template files to utilize when creating deliverables.

Template files can be constructed in a scripting language such as AviSynth™. AviSynth™ essentially acts as a frameserver program or a non-linear video editor that is controlled entirely by scripting and stands as an intermediary between the digital file and a receiving program such as an encoder or media player. Different template files are established for different types of deliverables. For example, one template file may provide the settings for a high definition 16×9 aspect ratio 25 fps deliverable while another template file may provide for an NTSC 4×3 aspect ratio 30 fps deliverable.

Table A illustrates a sample template file used in accordance with one or more embodiments of the invention.

TABLE A
<NAME>Sample Template</NAME>
<DESC>Sample Description Here</DESC>
<DESTTYPE>Surround</DESTTYPE>
<DESTPATH_L>W:\xxx\51_LEFT\</DESTPATH_L>
<DESTPATH_C>W:\xxx\51_CENTER\</DESTPATH_C>
<DESTPATH_R>W:\xxx\51_RIGHT\</DESTPATH_R>
<DESTPATH_LS>W:\xxx\51_LEFTSURROUND\</DESTPATH_LS>
<DESTPATH_RS>W:\xxx\51_RIGHTSURROUND\</DESTPATH_RS>
<DESTPATH_LFE>W:\xxx\51_LFE\</DESTPATH_LFE>
<OUTPUTNAME>Title%WPR%Aspect%Notes%TemplateName<OUTPUTNAME>
<SLATE_AUDIOCONFIG_1>Ch. 1 & 2 Text</SLATE_AUDIOCONFIG_1>
<SLATE_AUDIOCONFIG_2>Ch. 3 & 4 Text</SLATE_AUDIOCONFIG_2>
<SLATE_AUDIOCONFIG_3>Ch. 5 & 6 Text</SLATE_AUDIOCONFIG_3>
<SLATE_ASPECT>178 </SLATE_ASPECT>
<SLATE_FRAMERATE>24 fps.</SLATE_FRAMERATE>
<SLATE_RESOLUTION>1920×1080</SLATE_RESOLUTION>
<<AVISOURCE>>
<<FADE>>
<<FADEVAL>>
<<GAMMA>>

| | |
|---|---|
| <<TRIM>> | (MARKET BASED) |
| <<INPOINT>> | (MARKET BASED) |
| <<OUTPOINT>> | (MARKET BASED) |

The beginning of TABLE A provides a name and description for the particular template (i.e., Sample Template). The various <DESTPATH> tags are then utilized to specify the path/location for the different 5.1 surround sound channels. The sample template file also includes an output deliverable naming convention that allows for multiple output deliverable naming conventions to be used within the encoding tool. Accordingly, the <OUTPUTNAME> tag allows the definition of a naming convention for the output. In Table A, the naming convention provides for using the title, the WPR (worldwide product registry) (i.e., a six digit alphanumeric identification that defines the media), the aspect ratio, notes, and the template name.

The next series of tags provide information relating to the slate to be used for the particular deliverable. A slate provides descriptive and technical metadata in a video form. In this regard, a slate is typically black on white (or vice versa) and describes downstream media such as the title, running time, format, resolution, number of channels of audio, etc. When a slate (or portion of a slate) is defined in the template file, the defined portion of slate generates a frame of the slate and passes it into the video stream while removing a portion of the existing/resident slate in the video digital file. In this regard, either a portion of the slate or the entire slate may be replaced by the definition specified.

After the slate definition, tags for various script commands are utilized to manipulate and/or edit the digital file. Table A illustrates some of the types of script command that can be utilized. For example, AVISOURCE could be utilized to specify the name of a file (i.e., an AVI file or otherwise) to read in. The FADE command may be utilized to specify a fade operation with the FADEVAL specifying a parameter for use in the fade operation. Similarly, the gamma, trim, inpoint, and outpoint commands may specify other parameters for manipulating the digital file. Additional settings and values may be specified as part of these commands as well (not shown in Table A).

TABLE B illustrates an additional sample template file used in accordance with one or more embodiments of the invention.

TABLE B
<CONFIG>
<DESTTYPE>Normal</DESTTYPE>
<DESTPATH>W:\WatchFolders\DR_EncodeTool_v2\
TVD_QD\PAL_16×9_25fps\</DESTPATH>
<OUTPUTNAME>Title%WPR%001_178_25_50_608I_ENG_QD</
OUTPUTNAME>
<SLATE_AUDIOCONFIG_1></SLATE_AUDIOCONFIG_1>
<SLATE_AUDIOCONFIG_2></SLATE_AUDIOCONFIG_2>
<SLATE_AUDIOCONFIG_3></SLATE_AUDIOCONFIG_3>
<SLATE_AUDIOCONFIG_4></SLATE_AUDIOCONFIG_4>
<SLATE_ASPECT>178 </SLATE_ASPECT>
<SLATE_FRAMERATE>24 fps.</SLATE_FRAMERATE>
<SLATE_RESOLUTION>1920×1080</SLATE_RESOLUTION>
</CONFIG>
LoadPlugin(“C:\Program Files\AviSynth 2.5\plugins\ColorMatrix.dll”)
<<DSSOURCE>>
<<TRIM>>
ColorMatrix(mode=“Rec.709->Rec.601”)
<<CROP>>
ReduceBy2( )
LanczosResize(720,576)
AddBorders(0,32,0,0)
AssumeFPS(25, 1, true)
SSRC(48000)
<<FADE>>

Table B first specifies the destination location where the file/stream should be output along with the name of the file. The slate information is then specified similar to that of Table A. Thereafter, a plugin for performing a color space modification is loaded (e.g., using the LoadPlugin( ) command). A trim (i.e., using the <<TRIM>> command) of the content is performed (the trim values may be specified during execution [e.g., via user input]). A color space transformation is performed converting the content from high definition color space (709) into PAL color space (601). The content is then cropped (using the <<CROP>> command), a gamma color correction is performed, and the content is resized. Borders are added (e.g., using the AddBorders( ) command) and a frame rate conversion is performed to 25 frames per second. The last two commands provide for modifying the audio source and performing a fade out.

As described above, the various template files provide the ability to specify the conditions and parameters for manipulating a digital file and creating individual deliverable file clips (that are streamed). Templates may be grouped together into different “markets” that may be displayed in a group or a tabbed setting to provide an efficient mechanism for the user to select one or more desired templates. The different groupings and markets may be specified (to organize a graphical user interface) using a configuration file.

Table C illustrates a sample configuration file that may be used in accordance with one or more embodiments of the invention.

TABLE C
<Markets>
<market market_name=“TVD_QD from HD Source”>
<defaultTrimOption>Fade</defaultTrimOption>
<defaultGammaOption>Off</defaultGammaOption>
<defaultCropValues>0,0,0,0</defaultCropValues>
<template>W:\Scripts\EncodeToolConfigs\TVD_QD\HD_16×9_25fps_QD.avst</template>
<template>W:\Scripts\EncodeToolConfigs\TVD_QD\HD_16×9_30fps_QD.avst</template>
<template>W:\Scripts\EncodeToolConfigs\TVD_QD\PAL_16×9_25fps_QD.avst</template>
<template>W:\Scripts\EncodeToolConfigs\TVD_QD\NTSC_4×3_30fps_QD.avst</template>
<template>W:\Scripts\EncodeToolConfigs\TVD_QD\HD_25fps_Limited_MPA_QD.avst</template>
<template>W:\Scripts\EncodeToolConfigs\TVD_QD\25fps_51_WAV_QD.avst</template>
</market>
<market market_name=“EST from HD Source”>
<defaultTrimOption>Fade</defaultTrimOption>
<defaultGammaOption>Off</defaultGammaOption>
<defaultCropValues>0,0,0,0</defaultCropValues>
<template>W:\Scripts\EncodeToolConfigs\EST\DigitalCopy_178_24fps.avst</template>
<template>W:\Scripts\EncodeToolConfigs\EST\DigitalCopy_185_24fps.avst</template>
<template>W:\Scripts\EncodeToolConfigs\EST\DigitalCopy_235_24fps.avst</template>
<template>W:\Scripts\EncodeToolConfigs\EST\DigitalCopy_240_24fps.avst</template>
<template>W:\Scripts\EncodeToolConfigs\EST\ScreeningRoom_16×9_24fps.avst</template>
<template>W:\Scripts\EncodeToolConfigs\EST\iTunes_SD_16×9_24fps.avst</template>
<template>W:\Scripts\EncodeToolConfigs\EST\Move_HD_16×9_24fps.avst</template>
<template>W:\Scripts\EncodeToolConfigs\EST\51_WAV.avst</template>
</market>
</Markets>

The configuration file of Table C first specifies the name of the market, “TVD_QD from HD Source” followed by default trim, gamma, and crop values. Each of the templates within the TVD_QD from HD Source market is then specified (along with the location of the template file). The second market specified in Table C is “EST from HD Source” which is similarly followed with tags for default settings and tags identifying the locations of the different template files within the EST from HD Source market.

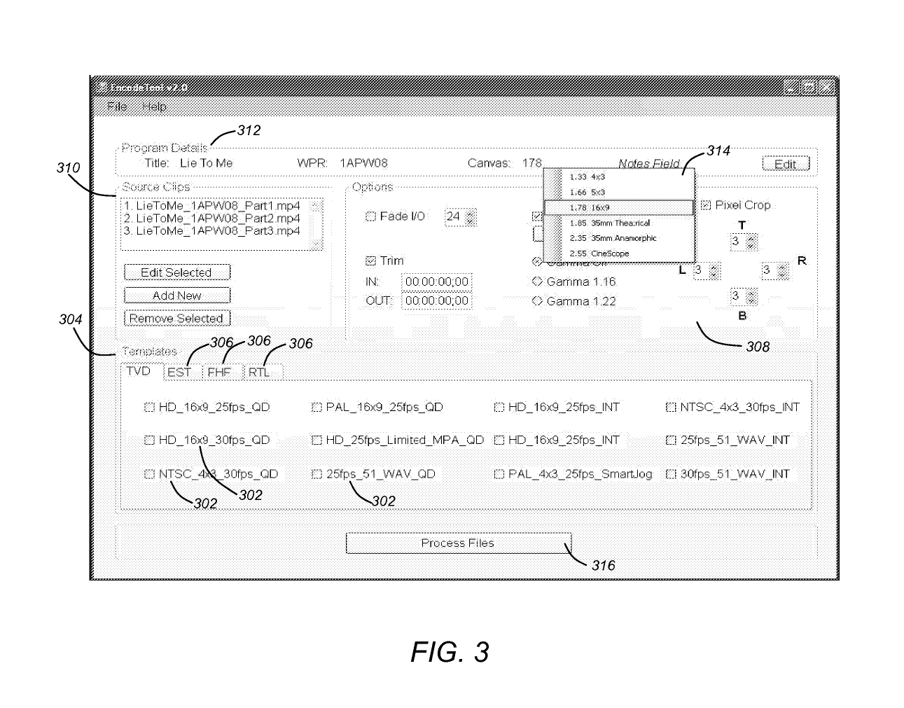

In addition to specifying settings within each template, similar settings may be set at a master level that can be used to override the individual template settings. Such master settings may be specified using a graphical user interface (of the encoding tool) that the user also utilizes to load selected media (e.g., source clips). FIG. 3 illustrates a graphical user interface of an encoding tool in accordance with one or more embodiments of the invention.

As illustrated in FIG. 3, the individual templates 302 are displayed in area 304 with the tabs 306 representing the different markets. The user can select the different templates 302 by activating the checkboxes associated with each template 302. In addition, the master settings that override the template settings can be configured in options area 308. In an alternative embodiment, the individual settings within template files 302 may be used to override the master settings established in options area 308. Options area 308 provides the ability to establish the fade, gamma, trim, and cropping to be utilized for a given source clip. For example, the first twenty-four frames of a source clip may be black. The trim option may be utilized to trim out these twenty-four frames thereby modifying the running time of the clip.

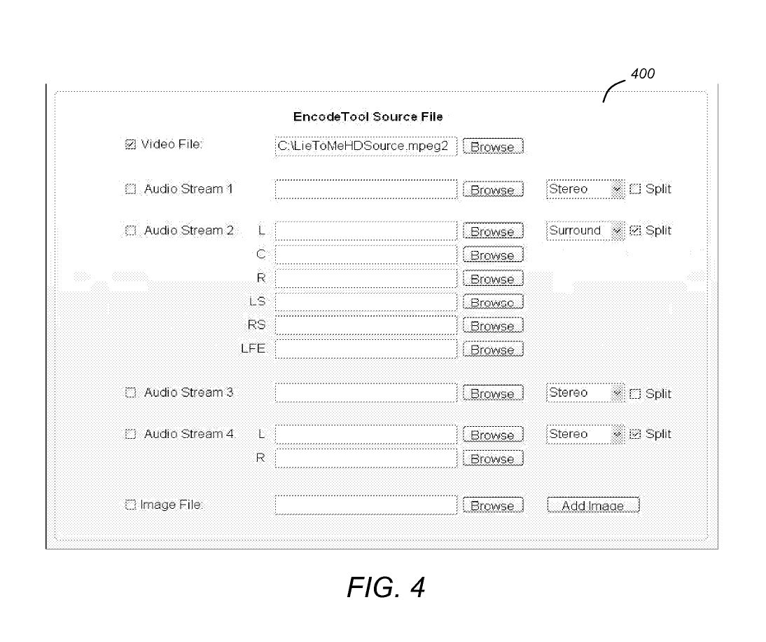

To utilize each of the selected template files 302, the user may first be required to define the media that the templates are to operate on. To determine which program/digital file to utilize for processing, various source clips may be loaded and displayed in area 310. FIG. 4 illustrates a source file definition user interface that may be utilized to select and add source files in accordance with one or more embodiments of the invention. In the source file user interface 400, the user has the option of loading different video files, audio streams, and images along with various settings for each file. To specify a particular file, the user simply selects the appropriate checkbox and browses for the desired file. Alternatively, the user can first select a file and the checkbox would automatically activate once a file has been selected. In yet another embodiment, source files can simply be dragged and dropped as desired. Further, the user has the option to select interleaved or discrete sources to represent a surround sound stream (e.g., where the user may select six sources).

Referring again to FIG. 3, the user also has the capability to edit the program details information in area 312. By selecting the edit button within program details 312, the user can type/edit the title, the worldwide product registry identification, the canvas, and the notes (e.g., theatrical distribution). As illustrated in FIG. 3, the user is editing the canvas within program details 312 and a drop down menu 314 is displayed allowing the user to select the desired size of the canvas to utilize as output.

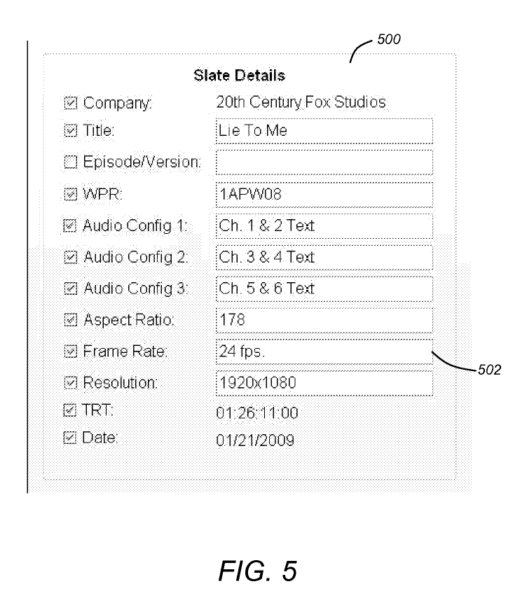

Slate options may also be activated using user interface 300. A slate tab may only be available at a master level for configuration and any template may include or exclude slate options. For example, for a certain template, it may be desirable to never utilize a slate. The slate options generate descriptive and technical metadata in a video form using a user interface. FIG. 5 illustrates a sample slate details user interface 500 that can be used to configure a slate to be utilized as the master slate for all distributables in accordance with one or more embodiments of the invention. The slate settings 500 allows the user to configure a slate that will be displayed preceeding the actual source material in the output deliverable.

Once configurations are established and templates selected, the user has the option of previewing the result. A temporary file is generated on disk (e.g., in random access memory) and is displayed for the user in a preview capability. Accordingly, all adjustments are previewable and afterwards can be pushed out to a render farm to generate/render the deliverable. The deliverables can be previewed on the fly based on template settings, master clip settings, or both settings as desired. In this regard, the ability for a user to preview clips without generating an entire rendered deliverable not only reduces errors in a deliverable but saves time and resources.

Once all of the parameters and templates have been specified, the user can select the process files button 316. The processing generates scripting syntax that can be used by an encoder or frame server to generate the desired deliverables.

### Example Feature Set

In view of the above, the encoding tool and configurations/templates provide various features including slate/countdown, multi-source splice, multi-stream audio, image burn-in/overlay, subtitling support, video edge cropping, projects, in/out trim points, auto fade in/out, and gamma adjustment. Each of these features is discussed in detail below.

Slate/Countdown Option: Referring to FIG. 5, when the slate/countdown option is activated, a broadcast-ready leader is automatically inserted into clip. The leader contains a slate, black, and a 2-pop countdown at the beginning of the output stream, preceding the actual source material. The duration for the slate and black time is calculated based on the frame rate 502 desired for an output deliverable. A text input section on the user interface 500 allows the user to specify what information they would like displayed on the generated slate (e.g., title, WPR, audio configurations, etc.). Multiple countdown video files (uncompressed HD/AVI) may be provided to allow the insertion of the appropriate countdown file for the frame rate specified within an output deliverable.

Multi-Source Splice: A multi-source splice allows for an unlimited number of source material files to be joined together to form a single master source object (to be processed further by the tool). The splice option may also support splicing separate audio and image files, along with video files, following the same master clip timings.

Multi-Stream Audio: Embodiments of the invention provide the ability to embed multiple audio streams into an output deliverable, from separate source audio files. This feature may also provide the option to specify the channel assignment/ordering of the embedded audio streams on a per-template basis. For example:

Channels 1-6->Stream 1 (5.1 Surround)

Channels 7-8->Stream 2 (English Stereo)

Channels 9-10->Stream 3 (Stereo Laugh Track)

Supported audio file types for this feature may include WAV/PCM, AAC, MP3, MP1, MP2, MPA, AC3, DTS, and LPCM (Raw digital audio).

Image Burn-In/Overlay: This option allows the user to specify an image file and optional X-Y pixel offset values per source material file, to overlay in an output deliverable. Supported file types for this feature may include JPEG, BMP, PAL, PCX, PNG, EBMP (RIFF base), TGA, TIFF, and SGI/RGB/RGBA.

Subtitling Support: In utilizing subtitling support, the user may provide an XML (extensible markup language) file, and select the directory where each individual subtitle image is stored with a sequential order naming schema. Thereafter, the appropriate ImageSource and Splice AviSynth tags are inserted such that each subtitle image is overlayed at the specified position in the provided XML file.

Video Edge Cropping: This feature allows the user to specify pixel values for cropping the edges of source clips that have been loaded. Format-based standards may be enforced in this feature, ensuring equal pixel values are used across all 4 crop points.

Projects: The concept of projects allows the user to store frequently used configurations (e.g., the selection of all templates normally selected for a weekly television production). These projects will be stored and recalled locally on computers utilizing embodiments of the invention.

AVST Template Editor: The AVST Template Editor feature allows the user to build and modify template files, easily specify a name, description, type (Normal or Surround), destination path(s), and output naming convention. This feature may provide assistance with generating scripting (e.g., AviSynth) code.

In/Out Trim Points: This feature allows for the user to select In/Out points to begin and end source materials within an output deliverable.

Auto Fade In/Out: This feature allows for an automatic fade in/out from black to be placed at the beginning and/or end of the final generated output deliverable, with the option to specify fade duration.

Gamma Adjustment: This feature provides a simple method to raise the gamma levels by two predefined amounts, (e.g., 1.16 and 1.22) automatically, within the final generated output deliverable.

### Logical Flow

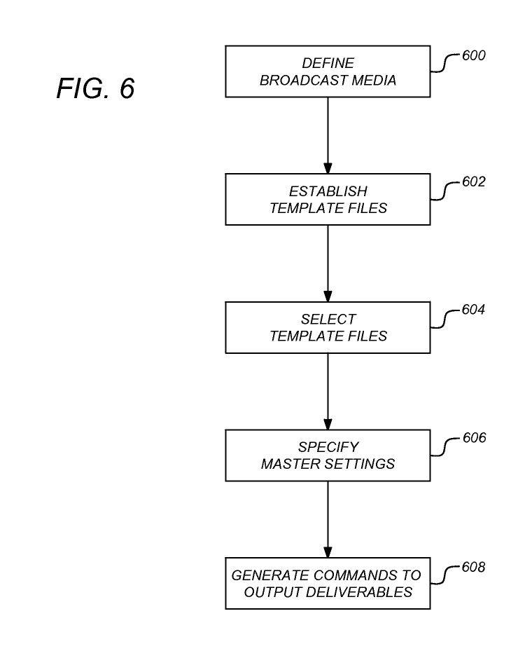

FIG. 6 illustrates the logical flow for enabling the generation of a media content deliverable in accordance with one or more embodiments of the invention. Such media content may be broadcast, streaming, or downloadable media

At step 600, the media content is defined. For example, one or more source clips may be selected (e.g., using a drag and drop of source clips into a graphical user interface or by browsing for a file).

At step 602, one or more template files are established. Each template file contains settings to generate one or more commands that operate on the media content to output a different deliverable. The commands may be written in a scripting language (e.g., Avisynth). Further, each template file can specify a sequence/order for performing the commands.

At step 604, one or more of the template files are selected (e.g., by the user via a graphical user interface). The templates can be organized/grouped into markets with each market being separately selectable thereby enabling the selection of a template within a selected market. For example, each market may be displayed in a separate tab of a display with the templates in each market appearing on the respective tab. The grouping of the markets and the locations of each of the template files may be specified using a configuration file (e.g., in a tagged or XML based format). Multiple template files can be simultaneously selected (e.g., once multiple template files have been selected, the selection of the multiple files may be indicated in a graphical user interface [e.g., via checkboxes, radio buttons, etc.]).

A slate may further be defined that is used to generate descriptive and technical metadata in a video form that is used/inserted into the deliverable.

At step 608, the one or more command are generated based on each of the selected template files and the master settings. The commands may then be utilized to output one or more of the deliverables (e.g., as a stream of frames to a frame server). In this regard, multiple deliverables are output as streams based on the templates and settings.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer implemented method for simultaneously generating a broadcast media content deliverable, comprising:
(a) defining media content;
(b) establishing one or more template files, wherein each template file comprises settings to generate one or more commands that operate on the media content to output a different deliverable;
(c) selecting one or more of the template files;
(d) specifying master settings for the media content; and
(e) generating the one or more commands based on each of the selected template files and the master settings, wherein the one or more commands are utilized to output one or more of the deliverables.

2. The method of claim 1, wherein the media content is defined by selecting one or more source clips.

3. The method of claim 1, wherein the one or more commands are written in a scripting language.

4. The method of claim 1, wherein each template file comprises a sequence for performing the one or more commands.

5. The method of claim 1, further comprising grouping two or more of the templates into two or more markets, wherein each market is separately selectable by a user to enable selection of a template within the market.

6. The method of claim 5, wherein the grouping, the two or more markets, and locations of each of the one or more template files are specified using a configuration file.

7. The method of claim 1, further comprising displaying a graphical user interface indicating a simultaneous selection of two or more of the template files.

8. The method of claim 1, further comprising defining a slate that generates descriptive and technical metadata in a video form that is used in the deliverable.

9. The method of claim 1, further comprising outputting the one or more deliverables as a stream of frames to a frame server.

10. An apparatus for simultaneously generating a media content deliverable in a computer system comprising:
(a) a computer having a memory;
(b) an application executing on the computer, wherein the application is configured to
(i) define media content;
(ii) establish one or more template files, wherein each template file comprises settings to generate one or more commands that operate on the media content to output a different deliverable;
(iii) select one or more of the template files;
(iv) specify master settings for the media content; and
(v) generate the one or more commands based on each of the selected template files and the master settings, wherein the one or more commands are utilized to output one or more of the deliverables.

11. The apparatus of claim 10, wherein the media content is defined by selecting one or more source clips.

12. The apparatus of claim 10, wherein the one or more commands are written in a scripting language.

13. The apparatus of claim 10, wherein each template file comprises a sequence for performing the one or more commands.

14. The apparatus of claim 10, wherein the application is further configured to group two or more of the templates into two or more markets, wherein each market is separately selectable by a user to enable selection of a template within the market.

15. The apparatus of claim 14, wherein the grouping, the two or more markets, and locations of each of the one or more template files are specified using a configuration file.

16. The apparatus of claim 10, wherein the application is further configured to display a graphical user interface indicating a simultaneous selection of two or more of the template files.

17. The apparatus of claim 10, wherein the application is further configured to define a slate that generates descriptive and technical metadata in a video form that is used in the deliverable.

18. The apparatus of claim 10, wherein the application is further configured to output the one or more deliverables as a stream of frames to a frame server.

19. A computer readable storage medium encoded with computer program instructions which when accessed by a computer cause the computer to load the program instructions to a memory therein creating a special purpose data structure causing the computer to operate as a specially programmed computer, executing a method of simultaneously generating a media content deliverable, comprising:
(a) defining, in the specially programmed computer, media content;
(b) establishing, in the specially programmed computer, one or more template files, wherein each template file comprises settings to generate one or more commands that operate on the media content to output a different deliverable;
(c) selecting, in the specially programmed computer, one or more of the template files;
(d) specifying, in the specially programmed computer, master settings for the media content; and
(e) generating, in the specially programmed computer, the one or more commands based on each of the selected template files and the master settings, wherein the one or more commands are utilized to output one or more of the deliverables.

20. The computer readable storage medium of claim 19, wherein the media content is defined by selecting one or more source clips.

21. The computer readable storage medium of claim 19, wherein the one or more commands are written in a scripting language.

22. The computer readable storage medium of claim 19, wherein each template file comprises a sequence for performing the one or more commands.

23. The computer readable storage medium of claim 19, further comprising grouping two or more of the templates into two or more markets, wherein each market is separately selectable by a user to enable selection of a template within the market.

24. The computer readable storage medium of claim 23, wherein the grouping, the two or more markets, and locations of each of the one or more templates files are specified using a configuration file.

25. The computer readable storage medium of claim 19, further comprising displaying a graphical user interface indicating a simultaneous selection of two or more of the template files.

26. The computer readable storage medium of claim 19, further comprising defining a slate that generates descriptive and technical metadata in a video form that is used in the deliverable.

27. The computer readable storage medium of claim 19, further comprising outputting the one or more deliverables as a stream of frames to a frame server.
